(19) United States
(12) Patent Application Publication
(10) Pub. No.: US 2025/0325453 A1
(43) Pub. Date: Oct. 23, 2025

(54) Dual Purpose Teething Toy Picture Frame

(71) Applicant: Musa Al-Sulaimani, Port Matilda, PA (US)

(72) Inventor: Musa Al-Sulaimani, Port Matilda, PA (US)

(21) Appl. No.: 19/098,559

(22) Filed: Apr. 2, 2025

Related U.S. Application Data
(60) Provisional application No. 63/631,205, filed on Apr. 8, 2024.

(51) Int. Cl. A61J 17/00; A47G 1/06; A61J 17/02

(52) U.S. Cl. CPC A61J 17/111; A47G 1/0611; A47G 1/0627; A61J 17/001; A61J 17/02

(57) ABSTRACT

A multi-functional infant device that serves both as a teething toy and a picture display or mirror assembly. The device comprises an external oral stimulation surface formed from a soft, infant-safe material and an internal frame configured to hold either one or more transparent or translucent layers or a reflective surface. These layers are designed to retain a photograph, printed insert, or mirror, and are secured in place by a two-part interlocking internal frame. The outer case fully encloses the internal frame and features textured extrusions to provide varied teething surfaces for sensory stimulation. The overall structure may be shaped in various configurations, including geometric or thematic outlines, and includes optional attachment features for portability. The invention enables visual engagement and teething relief in a single compact assembly, designed for safe use by infants.

### CROSS-REFERENCE TO RELATED APPLICATIONS

This Patent Application claims priority to U.S. Provisional Patent Application No. 63/631,205, filed on Apr. 8, 2024, titled “Dual Purpose Teething Toy Picture Frame”

### FIELD OF TECHNOLOGY

Embodiments of the present disclosure are directed to a multi-functional infant teether, and more particularly, a baby teether with an integrated sensory stimulation system that includes textured oral relief surfaces, a customizable photo slot, and a shatterproof mirror for visual engagement.

### BACKGROUND OF THE INVENTION

The teething process in infants is often painful and stressful. Parents typically provide teether devices to help soothe an infant's gums. However, existing teether products lack multi-functionality or meaningful visual stimulation. There remains a need for a device that not only soothes infants during teething but also serves as a picture or mirror display for sensory or emotional engagement.

### SUMMARY OF THE INVENTION

The present invention provides a dual-purpose device that combines an infant-safe teething toy with a picture frame or mirror assembly. The device includes an outer case made of a soft, chewable material that encases a rigid or semi-rigid inner frame. This frame holds either one or two transparent layers or a mirror for displaying photos, illustrations, or reflections. The invention is safe for oral use, customizable in shape, and adaptable for multiple visual or tactile experiences.

### BRIEF DESCRIPTION AND DRAWINGS

FIG. 1 is an exploded perspective view of all the components of the nibble frame, including the outer teething case, the male and female parts of the inner frame, and two transparent film layers.

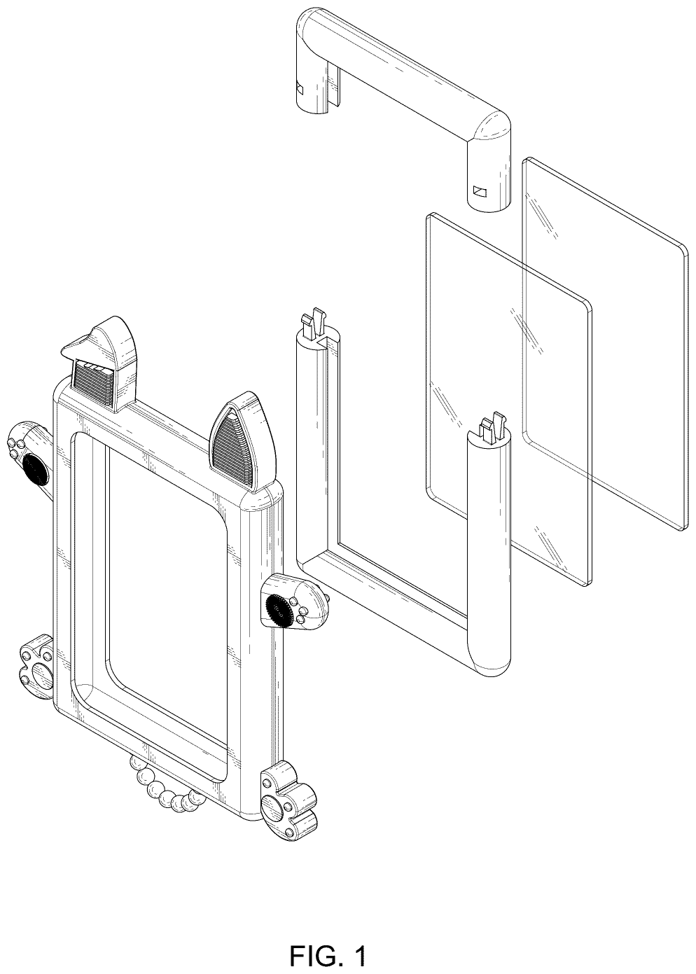

FIG. 2 is a perspective view of the assembled nibble frame showing the outer teether structure and enclosed picture area.

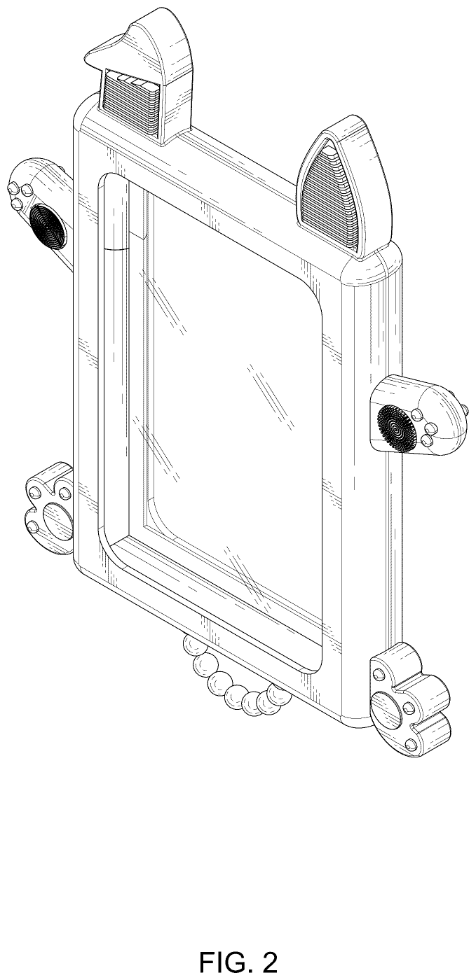

FIG. 3 is a front view of the assembled nibble frame.

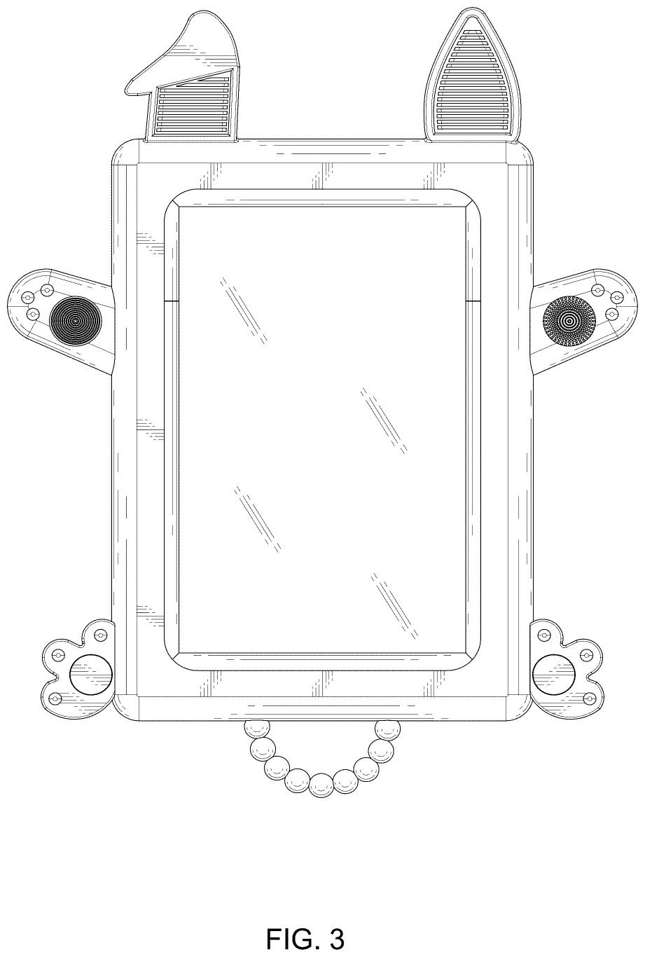

FIG. 4 is a rear view of the assembled nibble frame.

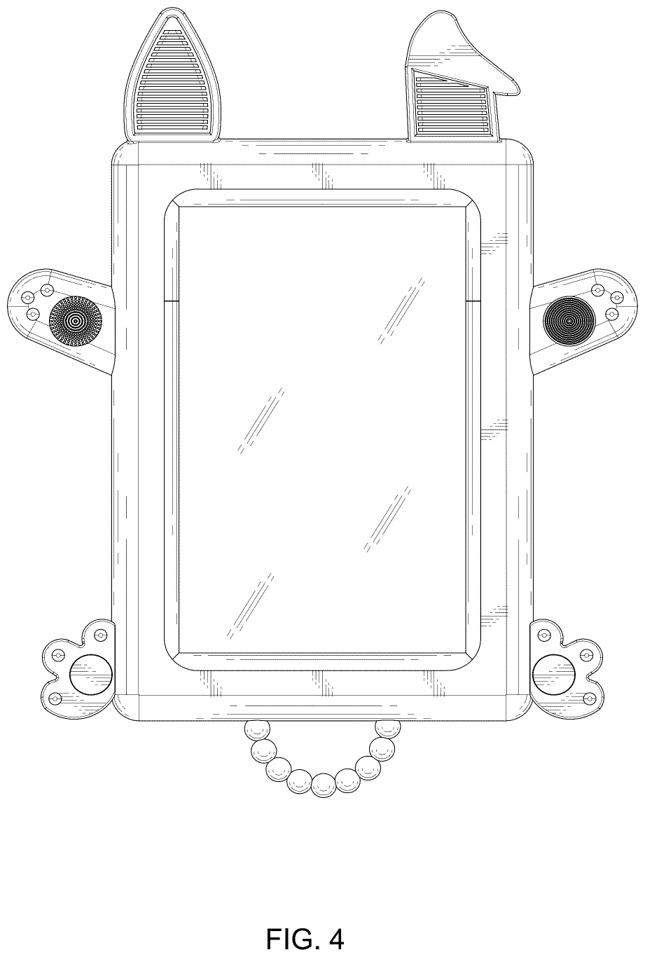

FIG. 5 is a top view of the assembled nibble frame.

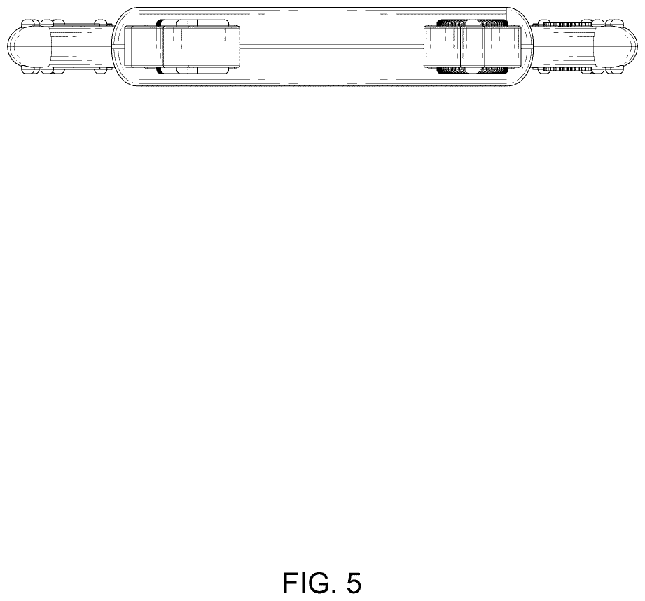

FIG. 6 is a bottom view of the assembled nibble frame.

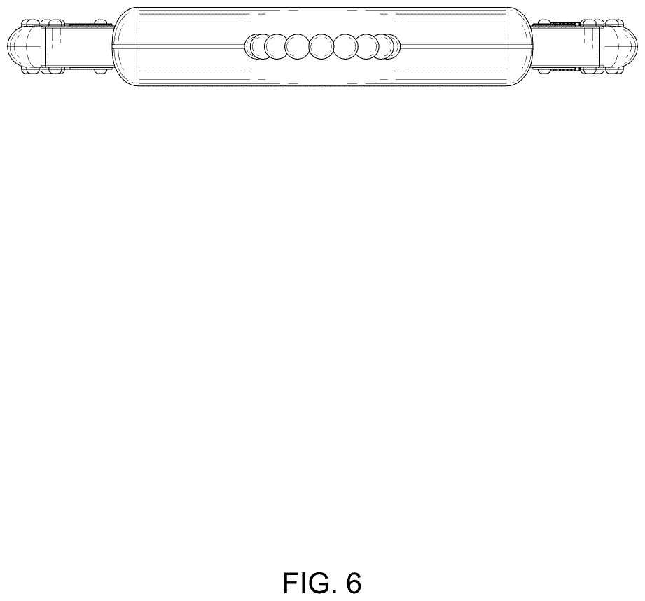

FIG. 7 is a left-side view of the assembled nibble frame.

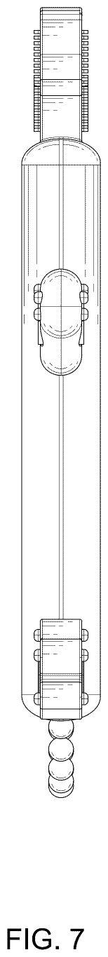

FIG. 8 is a right-side view of the assembled nibble frame.

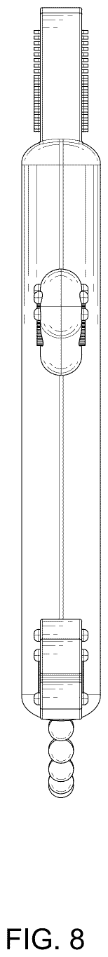

### DETAILED DESCRIPTION OF THE INVENTION

The invention comprises three major components: (1) a transparent or translucent layer (or a mirror), (2) an internal frame configured to secure the visual insert, and (3) an external case formed of soft, chew-safe material. The internal frame includes male and female locking parts and may contain a guiding track for secure alignment. The outer case features surface textures such as bumps, ridges, or nubs to assist in teething. The frame may take the form of animals, geometric shapes, or abstract outlines, offering aesthetic variety. The visual insert may be a photograph, artwork, or a mirror to support developmental engagement.

1. 1. A multi-functional infant device comprising: at least one transparent or translucent layer configured to retain a visual insert; an internal structural frame configured to support and secure the at least one transparent layer, an external oral stimulation surface configured for safe biting, chewing, or sucking by an infant; wherein the external oral stimulation surface encloses at least a portion of the internal structural frame.

2. The device of claim 1, wherein the transparent layer comprises a flexible polymer film or a rigid polymer sheet.

3. The device of claim 1, wherein the visual insert is a photograph, illustration, or printed paper.

4. The device of claim 1, wherein the internal structural frame comprises a male portion and a female portion configured to interlock or snap-fit to secure the transparent layer.

5. The device of claim 1, wherein the external oral stimulation surface comprises one or more surface textures selected from the group consisting of: bumps, ridges, nodes, teeth-like extrusions, or undulations.

6. The device of claim 1, wherein the external oral stimulation surface is made of food-grade silicone or thermoplastic elastomer.

7. The device of claim 1, wherein the transparent layer is configured to sandwich the visual insert between two transparent layers.

8. The device of claim 1, wherein the internal frame further comprises an alignment track along an interior perimeter to guide the transparent layer into position.

9. The device of claim 1, wherein the device is generally rectangular, circular, or oval in shape.

10. The device of claim 1, wherein the external oral stimulation surface is integrally molded with the internal frame.

11. The device of claim 1, wherein the device includes at least one attachment element selected from the group consisting of: clip, loop, tether point, or strap.

12. The device of claim 1, wherein the external oral stimulation surface comprises varying durometers for differential teething relief.

13. The device of claim 1, wherein the transparent layer includes anti-fog or anti-glare treatment.

14. A method of manufacturing the device of claim 1, comprising the steps of: forming at least two transparent layers; inserting a visual insert between the transparent layers;
securing the transparent layers within an internal frame; enclosing the frame within an external teething-safe structure; wherein the final product provides both visual engagement and teething relief.

15. The device of claim 1, wherein the visual insert is a mirror.

16. The device of claim 1, wherein the internal frame locking mechanism includes snap-fit, screw-fit, or sliding latches.

17. The device of claim 1, further comprising a detachable key or unlocking clip configured to disengage a safety locking mechanism between the male and female portions of the internal structural frame, wherein said mechanism prevents unintended separation of the transparent layer enclosure during normal use.

18. The device of claim 1, wherein the external shape is animal-themed or an irregular abstract design.
